(19) United States
(12) Patent Application Publication
(10) Pub. No.: US 2011/0057064 A1
(43) Pub. Date: Mar. 10, 2011

(54) BELT RETRACTOR

(75) Inventors: Dipl.-Ing. Armin TOTH, Dornstadt (DE); Rüdiger Paulsen, Ulm (DE)

(73) Assignee: TAKATA-PETRI AG

(21) Appl. No.: 12/874,028

(22) Filed: Sep. 1, 2010

(30) Foreign Application Priority Data
Sep. 4, 2009 (DE) 10 2009 040 689.1

(51) Int. Cl. B60R 22/36; B60R 22/34

(52) U.S. Cl. 242/376

(57) ABSTRACT

The invention relates to a belt retractor for a seat belt, with a belt reel (110) for winding up and unwinding the seat belt, and a lockable locking base (100) connected to the belt reel.

According to the invention, it is provided that an inner element (10) having a predetermined outer contour (30) is held rotatably in an outer element (40) having a predetermined inner contour (50), the outer contour or the inner contour having at least one deformable section (R1-Rn) by means of which the inner element and the outer element interact and which is deformed in the event of a relative rotation of the two elements, and the inner element being connected to the belt reel and the outer element being connected to the locking base or, conversely, the inner element being connected to the locking base and the outer element being connected to the belt reel.

The invention relates to a belt retractor for a seat belt having the features according to the preamble of claim 1.

A belt retractor of this type is known from German laid-open specification DE 10 2006 026 470 A1. This belt retractor has a belt reel for winding up and unwinding a seat belt, and a lockable locking flange connected to the belt reel. The locking flange and the belt reel are connected by a deformable pin which is pressed into a hole in the locking base and enters an opposite hole in the belt reel. In the event of a relative rotation between the locking base and the belt reel, the deformable pin is bent and, in the process, is pulled out of the hole in the belt reel. The torque required for this increases the belt extension force which can be transmitted by the belt retractor. The level of the belt extension force and the profile thereof can be set via the length of the pin and a suitable choice of material.

The invention is based on the object of indicating a belt retractor which is kept structurally simple and can be produced cost-effectively and enables an optimum profile of the belt strap extension force to be set via the belt strap extension length.

This object is achieved according to the invention by a belt retractor having the features according to patent claim 1. Advantageous refinements of the belt retractor according to the invention are indicated in dependent claims.

According thereto, it is provided according to the invention that an inner element having a predetermined outer contour is held rotatably in an outer element having a predetermined inner contour, the outer contour or the inner contour having at least one deformable section (R1-Rn) by means of which the inner element and the outer element interact and which is deformed in the event of a relative rotation of the two elements, and the inner element being connected to the belt reel and the outer element being connected to the locking base or, conversely, the inner element being connected to the locking base and the outer element being connected to the belt reel.

A substantial advantage of the belt retractor according to the invention is that the design of said belt retractor makes it possible for highly individual belt strap extension force profiles to be set: this is because all that needs to be done for this is for the deformable sections, which are provided either on the outer contour or the inner contour of the inner or outer element, to be correspondingly dimensioned. If sections which are thick or are wider, i.e. can be more difficult to deform, are used, higher belt strap extension forces are required in order to unroll the belt strap from the belt reel; if, by contrast, narrower or smaller deformable sections, i.e. sections which are simpler to deform, are used, the belt strap extension force required for unrolling the seat belt from the belt reel will be lower. In other words, the deformable sections therefore permit a specific setting of the belt strap extension force as a function of the belt strap extension length.

Another substantial advantage of the belt retractor according to the invention is that it is possible therewith out great effort for, for example, a relatively high restraint force to be achieved by the seat belt at the beginning of a forward displacement of an occupant, and, after unwinding of a predetermined belt strap extension length during the forward displacement of the occupant, for automatic switching over of the restraint force to a lower force level to be achieved.

The belt strap extension force can be set in a particularly simple and therefore advantageous manner via the belt strap extension length by the deformable sections being varied in width and/or thickness; in other words, it is therefore considered to be advantageous if there is a plurality of deformable sections differing in width and/or thickness.

The deformable sections preferably continuously increase or decrease in width and/or thickness, as seen in the belt unwinding direction of the belt reel, depending on whether a belt strap extraction force which rises with the belt strap extension, i.e. a progressive force profile, or a belt strap extension force which drops with the belt strap extension, i.e. a degressive force profile, is desired.

The deformable sections can be formed in a particularly simple and therefore cost-effective manner by compressive ribs, but other designs for the deformable sections are also possible

According to a particularly preferred refinement, the inner element or the outer element has at least one thickened portion which deforms the deformable section or the deformable sections in the event of a relative rotation between the inner element and the outer element. The thickened portions may be, for example, cam-shaped and form deformation cams for the deformation of the deformable sections.

The inner element or the outer element may also have, for example, a plurality of thickened portions which, for example, are arranged rotationally symmetrically. If, for example, there are three or more thickened portions, said thickened portions can be used for the radial mounting of the inner element within the outer element.

The deformable sections are preferably composed of such a material that they are irreversibly plastically deformed in the event of a relative rotation between the inner element and the outer element.

In order to simplify deformation of the deformable sections, it is considered to be advantageous if the deformable sections are composed of a softer material than the thickened portions. For example, the deformable sections are composed of aluminum and the thickened portions of zinc.

The deformable sections are preferably connected integrally to the inner or the outer element, for example are cast on the inner or the outer, for example annular, element. Casting simplifies the production process and therefore the production costs.

The thickened portions are preferably also connected integrally to the inner or the outer element, for example are cast on the inner or the annular element.

The outer element can be formed, for example, by an annular element, and the deformable sections can be arranged, for example, on the inner contour of the annular element.

According to a particularly preferred refinement, it is provided that the annular element is connected to the belt reel, for example as a single part or by casting, and the inner element is connected to the locking base, for example as a single part or by casting, and the inner element is held coaxially within the annular element of the belt reel.

The invention will be explained in more detail below with reference to exemplary embodiments; in the drawings, by way of example:

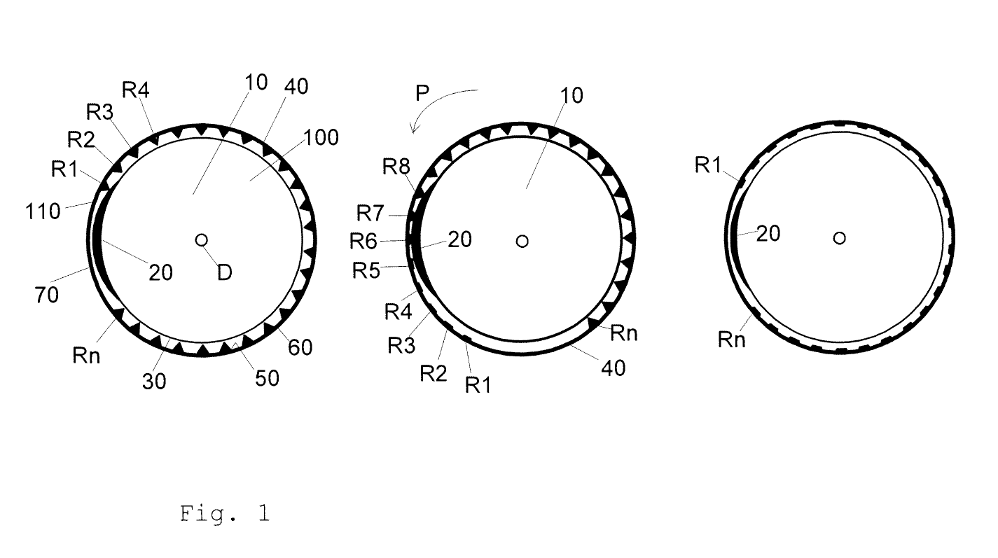

FIG. 1 shows components of a first exemplary embodiment for a belt retractor according to the invention with compressive ribs, wherein three different states of the belt retractor during extension of a belt strap while the locking base is locked are shown in FIG. 1,

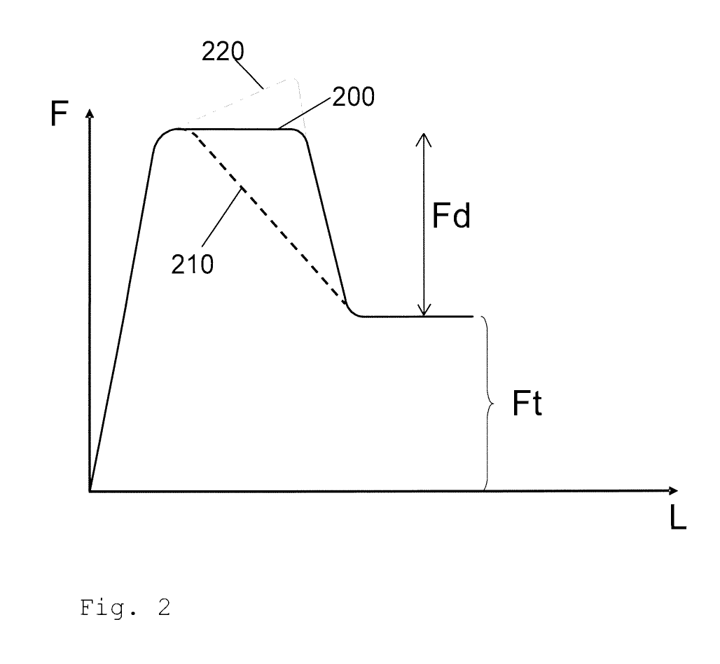

FIG. 2 shows the profile of the belt strap extension force as a function of the respective belt strap extension length for different configurations of the compressive ribs, and

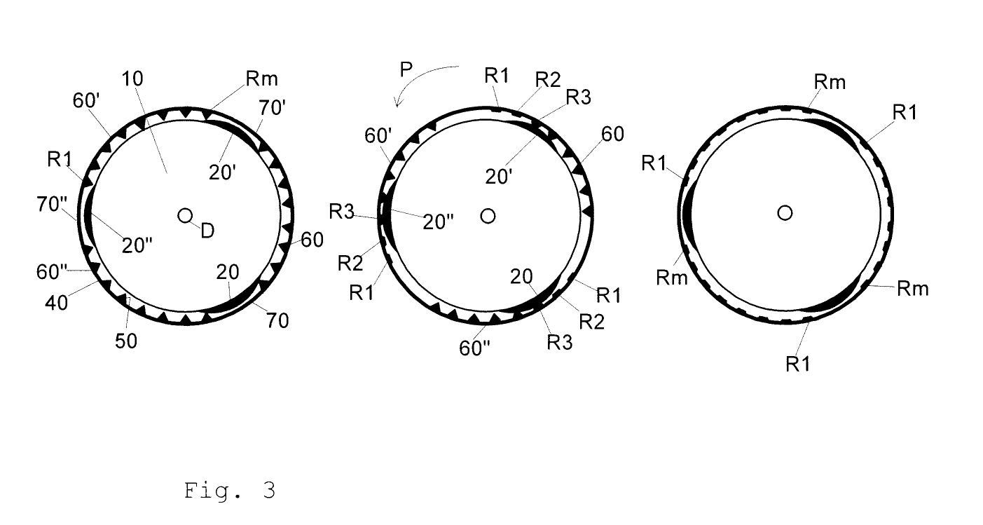

FIG. 3 shows components of a second exemplary embodiment for a belt retractor according to the invention, in which three cam-shaped thickened portions are provided for the deformation of deformable sections.

In the figures, for the sake of clarity, the same reference numbers are always used for identical or comparable components.

An inner element 10 which is mounted rotatably about an axis of rotation D can be seen in FIG. 1 (left-hand illustration). The inner element 10 has a thickened portion 20 which may be cam-shaped or may form a type of cam. The thickened portion 20 is arranged on the outer contour 30 of the inner element 10 or forms a section of said outer contour 30 of the inner element.

Furthermore, an outer element 40 which is of annular configuration and is likewise rotatable about the axis of rotation D and has an inner contour 50 can be seen in FIG. 1 (left-hand illustration). The inner contour 50 comprises an inner contour region 60 which is equipped with deformable sections in the form of compressive ribs R1, R2, R3, Rn. In addition, the inner contour 50 has a further inner contour region 70 which is free from compressive ribs or does not have any deformable sections in the form of compressive ribs.

As can furthermore be seen in FIG. 1 (left-hand illustration), the inner element 10 and the outer element 40 are arranged coaxially with respect to the axis of rotation D. In this case, at least sections of the inner element 10 engage in the outer element 40 such that the thickened portion 20 of the inner element 10 can interact with the compressive ribs R1 to Rn of the outer element 40, in particular if a relative rotation occurs between the inner element 10 and the outer element 40.

The starting point below by way of example is that the inner element 10 forms part of a locking base 100 of a belt retractor (not shown further in detail) and the outer element 40 forms part of a belt reel 110 of said belt retractor. The inner element 10 is preferably connected integrally, for example by casting, to the locking base 100; the same applies to the outer element 40, which is preferably connected integrally, for example by casting, to the belt reel 110.

In the initial position, as shown in the left-hand illustration of FIG. 1, the inner element 10 and the outer element 40 are aligned with respect to each other in such a manner that the thickened portion 20 is located within the inner contour region 70 without compressive ribs.

If now—for whatever reason, for example due to a person protected by the seat belt of the belt retractor being displaced forward because of inertia—the locking base 100 is locked by said locking base being connected, for example, to a frame of the belt retractor, the belt reel 110 will rotate relative to the locking base 100 if the belt strap extension force is of a sufficient magnitude and exceeds a required minimum force. The minimum force can be predetermined, for example, by any belt force limiting devices present—such as, for example, by one or more torsion bars. This is shown by way of example in the central illustration of FIG. 1.

It can be seen in the central illustration that the thickened portion 20 of the inner element 10 remains unrotated because the locking base 100 is locked whereas the belt reel together with the outer element 40 thereof is rotated further counter-clockwise along the arrow direction B. Owing to said further rotation, the first compressive rib R1 is plastically deformed or pressed flat by the thickened portion 20. The same applies to the compressive ribs R2 to R7, which are likewise deformed.

In the central illustration of FIG. 1, only the compressive ribs R8 to Rn have not yet been intercepted by the thickened portion 20 of the inner element 10, and therefore said compressive ribs are still undeformed. If the outer element 40 or the belt reel 110 is now rotated further relative to the inner element 10 or further relative to the locking base 100, as is shown by way of example in the right-hand illustration of FIG. 1, all of the compressive ribs R1 to Rn are pressed flat by the thickened portion 20. Therefore, all of the deformable sections are plastically deformed at the latest after one complete revolution of the belt reel 110 relative to the locked locking base 100 such that said sections can no longer generate any resistance force, or at least any significant resistance force, to a relative rotation between the belt reel 110 and the locking base 100.

FIG. 2 shows by way of example the profile of the belt strap extension force F, to be precise as a function of the respective belt strap extension length L after locking of the locking base 100. In the illustration according to FIG. 2, the starting point by way of example is that the force required for extension of the belt strap after locking of the locking base 100 is composed of a torsion force Ft required for twisting a torsion bar of the belt retractor and of the deformation force Fd required for the deformation of the deformable sections R1 to Rn.

Of course, in addition to a torsion bar or instead of a torsion bar, the belt retractor may also have other force limiting devices which determine the belt strap extension force required for further unrolling of the seat belt from the belt reel.

The solid line section 200 in FIG. 2 shows by way of example the profile of the belt strap extension force F for the situation in which all of the compressive ribs R1 to Rn are dimensioned identically and the thickened portion 20 requires the same force in each case for deformation of the compressive ribs.

Another exemplary embodiment is additionally sketched in FIG. 2 by means of a dashed line 210, in which the compressive ribs R1 to Rn are dimensioned differently, to be precise in such a manner that the force required for deformation or for pressing flat eases off during the extension of the belt strap and a degressive force profile is caused. In order to achieve the digressive profile identified by the reference number 210 in FIG. 2, the compressive ribs R1 to Rn may become, for example, smaller or thinner at an increasing differential angle relative to the thickened portion 20 (as seen from the starting position in the left-hand illustration of FIG. 1) in order to reduce the force required for pressing flat. The profile according to the line 210 can be achieved, for example, if:

G(Ri)<G(Ri−1) for 0<i≦n,

wherein G(Ri) describes the size or the deformation resistance of the respective compressive rib Ri. In this case, R1 denotes the first compressive rib which is intercepted and deformed by the thickened portion 20, and Rn denotes the final compressive rib which is intercepted and deformed by the thickened portion 20.

In addition, a chain-dotted line 220 in FIG. 2 identifies an exemplary embodiment in which the compressive ribs R1 to Rn are likewise dimensioned differently, but in a different manner, to be precise such that the force required for rotating the belt reel 110 relative to the locking base 100 increases as the belt strap extension length L increases. A progressive force profile of this type, as indicated by the line 220, can be caused, for example, by the compressive ribs R1 to Rn being designed to be continuously thicker and more stable (starting from the first compressive rib R1 intercepted by the thickened portion 20 to the final compressive rib Rn intercepted by the thickened portion 20) in order to make plastic deformation or pressing flat by the thickened portion 20 more difficult as the belt strap extension length increases. The profile according to the line 220 would therefore be achieved specifically if:

G(Ri)>G(i−1) for 0<i≦n,

wherein G(Ri) describes the size or deformation resistance of the respective compressive rib Ri.

It can also be seen in FIG. 2 that, after one complete revolution of the belt reel 110 relative to the locking base 100, the belt strap extension force is no longer determined by the compressive ribs R1 to Rn but rather a final value denoted by the designation Ft in FIG. 2 is achieved. The level of the remaining belt strap extension force Ft is therefore not determined by the deformable sections or the compressive ribs but solely or predominantly by other belt force limiting devices, such as, for example, a torsion bar of the belt retractor, if such a torsion bar is present.

FIG. 3 shows a further exemplary embodiment in which an inner element 10 is arranged coaxially within an outer element 40 and is rotatable about an axis D within the outer element 40.

In contrast to the exemplary embodiment according to FIG. 1, in the exemplary embodiment according to FIG. 3 the outer contour 30 of the inner element 10 is configured differently. Specifically, the inner element 10 has a total of three thickened portions 20, 20′ and 20″ which can each be designed to be cam-shaped or in the form of cams.

The outer element 40 has an inner contour 50 which comprises three inner contour regions 70, 70′ and 70″ without compressive ribs. In addition, there are three inner contour regions 60, 60′ and 60″ which are each provided with deformable sections in the form of compressive ribs R1 to Rm.

In the initial position as shown in the left-hand illustration of FIG. 3, the inner element 10 and the outer element 40 are aligned with respect to each other in such a manner that the thickened portions 20, 20′ and 20″ are each located within an associated inner contour region 70, 70′, 70″ without compressive ribs.

The inner element 10 is connected, for example, to the locking base of the belt reel. In a corresponding manner, the outer element 40, for example, forms part of the belt reel of the belt retractor.

If the locking base is now locked, a relative rotation between the belt reel and the locking base will occur in the event of a forced extension of the belt strap—for example in the event of a forward displacement of a vehicle occupant. Owing to such a relative rotation, the thickened portions 20, 20′ and 20″ will press the compressive ribs R1 to Rm flat in the inner contour region 60, 60′ and 60″ in each case associated therewith, thus resulting in a belt strap extension force profile as has been explained by way of example in conjunction with FIGS. 1 and 2.

A state is illustrated in FIG. 3 (central illustration) in which the three thickened portions 20, 20′ and 20″ have respectively deformed the first three compressive ribs R1 to R3 of the respectively associated inner contour region 60, 60′ and 60″.

FIG. 3 (right-hand illustration) shows a state according to which the belt reel 110 has executed a relative rotation of 120° with respect to the locking base and all of the compressive ribs R1 to Rm of all three inner contour regions 60, 60′ and 60″ have been pressed flat. In this state, the compressive ribs no longer carry out any force-increasing function, and therefore the belt strap extension force required for further extension of the belt strap is determined only by further belt force limiting means, for example torsion bars or the like, if the belt retractor is additionally provided with components of this type.

In the exemplary embodiment according to FIG. 3, the preferably rotationally symmetrically arranged thickened portions 20, 20′ and 20″ lead to radial guidance of the inner element 10 within the outer element 40 such that additional guidance of the two elements at a different location, for example in a cylindrical region of the belt reel and/or of the locking base, can be omitted.

An advantage of the belt retractors described by way of example in conjunction with FIGS. 1 to 3 is that said belt retractors provide a relatively high restraint force by means of the seat belt at the beginning of a forward displacement of an occupant; after a predetermined belt strap extension length has been unwound during the forward displacement of the occupant, the restraint force is then automatically switched over to a lower force level which is determined, for example, by a torsion bar or by a different force limiting device. In the exemplary embodiment according to FIG. 1, the switching over takes place after a belt strap extension length which corresponds to a relative angle of rotation between the locking base and the belt reel of 360°; in the exemplary embodiment according to FIG. 3, the switching over takes place after a belt strap extension length which corresponds to a relative angle of rotation between the locking base and the belt reel of 120°.

### LIST OF DESIGNATIONS

10 Inner element
20 Thickened portion
20′ Thickened portion
20″ Thickened portion
30 Outer contour
40 Outer element
50 Inner contour
60 Inner contour region
60′ Inner contour region
60″ Inner contour region
70 Inner contour region
70′ Inner contour region
70″ Inner contour region
100 Locking base
110 Belt reel
200 Section with constant extension force
210 Section with degressive extension force
220 Section with progressive extension force
D Axis of rotation
F Belt strap extension force
Fd Deformation force
Ft End value
L Belt strap extension length
P Arrow direction
R1-Rn Compressive ribs

1. A belt retractor for a seat belt, with
a belt reel for winding up and unwinding the seat belt, and
a lockable locking base connected to the belt reel,
wherein an inner element having a predetermined outer contour is held rotatably in an outer element having a predetermined inner contour,
the outer contour or the inner contour having at least one deformable section by means of which the inner element and the outer element interact and which is deformed in the event of a relative rotation of the two elements, and
the inner element being connected to the belt reel and the outer element being connected to the locking base or, conversely, the inner element being connected to the locking base and the outer element being connected to the belt reel.

2. The belt retractor as claimed in claim 1, wherein there is a plurality of deformable sections differing in width and/or thickness.

3. The belt retractor as claimed in claim 2, wherein the deformable sections continuously increase or decrease in width and/or thickness, as seen in the belt unwinding direction of the belt reel.

4. The belt retractor as claimed in claim 2, wherein the deformable sections are formed by compressive ribs.

5. The belt retractor as claimed in claim 1, wherein the inner element or the outer element has at least one thickened portion (20) which deforms the deformable section in the event of a relative rotation between the inner element and the outer element.

6. The belt retractor as claimed in claim 5, wherein the inner element or the outer element has a plurality of thickened portions which are arranged rotationally symmetrically.

7. The belt retractor as claimed in claim 2, wherein the deformable sections are composed of such a material or at least have such a material that they are irreversibly plastically deformed in the event of a relative rotation between the inner element and the outer element.

8. The belt retractor as claimed in claim 2, wherein the deformable sections are connected integrally to the inner or the outer element, for example are cast on the inner or outer element.

9. The belt retractor as claimed in claim 5, wherein the thickened portions are connected integrally to the inner or the outer element, for example are cast on the inner or outer element.

10. The belt retractor as claimed in claim 1, wherein the outer element is formed by an annular element in which the inner element is coaxially held.

11. A belt retractor for a seat belt, with
a belt reel for winding up and unwinding the seat belt, and
a lockable locking base connected to the belt reel,
wherein an inner element having a predetermined outer contour is held rotatably in an outer element having a predetermined inner contour,
the outer contour or the inner contour having at least one deformable section by means of which the inner element and the outer element interact and which is deformed in the event of a relative rotation of the two elements, and
the inner element being connected to the belt reel and the outer element being connected to the locking base or, conversely, the inner element being connected to the locking base and the outer element being connected to the belt reel,
the inner element or the outer element having a plurality of thickened portions which are arranged rotationally symmetrically and which deform the deformable section or the deformable sections in the event of a relative rotation between the inner element and the outer element,
the other element, i.e. the outer or the inner element, having an contour which comprises contour regions without deformable sections and contour regions which are each provided with deformable sections and
in the initial position both elements being aligned with respect to each other in such a manner that the thickened portions are each located within an associated contour region without deformable regions, and
the deformable sections continuously increasing or decreasing in width and/or thickness in the belt unwinding direction of the belt reel.

12. The belt retractor as claimed in claim 11, wherein the deformable sections are formed by compressive ribs.

13. The belt retractor as claimed in claim 11, wherein the deformable sections are composed of such a material or at least have such a material that they are irreversibly plastically deformed in the event of a relative rotation between the inner element and the outer element.

14. The belt retractor as claimed in claim 11, wherein the deformable sections are connected integrally to the inner or the outer element, for example are cast on the inner or outer element.

15. The belt retractor as claimed in claim 11, wherein the thickened portions are connected integrally to the inner or the outer element, for example are cast on the inner or outer element.

16. The belt retractor as claimed in claim 11, wherein the outer element is formed by an annular element in which the inner element is coaxially held.
